(19) United States
(12) Patent Application Publication
(10) Pub. No.: US 2014/0136445 A1
(43) Pub. Date: May 15, 2014

(54) SECURITIES LENDING RECORDS PROCESSING

(71) Applicant: SUNGARD DATA SYSTEMS INC., Wayne, PA (US)

(72) Inventors: Valarie Thorgerson, New Boston, NH (US); Payman Khodabandehloo, Harvard, MA (US); David Sean Van Anglen, Manchester, NH (US); Dmytro Vorobey, Richmond Hill (CA)

(73) Assignee: SUNGARD DATA SYSTEMS INC., Wayne, PA (US)

(21) Appl. No.: 13/677,461

(22) Filed: Nov. 15, 2012

(51) Int. Cl. G06Q 40/06

(52) U.S. Cl. 705/36 R

(57) ABSTRACT

A system for securities lending data management aggregates securities lending transaction data across a plurality of firms. The data comprises records including parameters for securities lending transactions entered into by individual firms. The system queries the data in order to identify instances wherein for a record of a transaction engaged by one firm, there is no corresponding record for another firm indicating a counterparty. The system compares instances of such orphan records in order to identify instances wherein the parameters for an orphan record corresponds to the parameters of another orphan record with the exception of perhaps one or two parameter values. The system outputs a listing of such instances and receives input confirming or invalidating that the identified orphan records correspond to the same transaction.

### BACKGROUND

The present application relates to securities lending, which may also be referred to as securities finance. This is different from the buying and selling of securities, which is more commonly known outside the financial services industry. When a security is sold, once the exchange is made between the buyer and the seller, the transaction has effectively ended, as has the temporary relationship between buyer and seller.

In securities lending, the transaction simply marks the beginning of a relationship between lender and borrower which may take many months or years. This relationship is usually consummated under the terms of a master agreement between borrower and lender, as well as the terms of individual contracts that define each loan and its corresponding borrow. These individual contracts represent the two sides of a transaction, the borrowers' side and the lenders' side and are kept on record separately at both parties. The parameters contained in these two sides of the transaction must be kept the same. However, as the prices of securities and interest rates change throughout the terms of the contract, so these parameters must be adjusted accordingly. For this reason, all participants in securities lending compare the parameters that comprise these contracts and report any discrepancies and automatically or manually make various adjustments to contracts, so that all business terms and regulatory requirements are kept up-to-date. Comparison is done at various points, either during the business day and/or following the close of business. This process also exposes any input errors that may have occurred during the creation of records.

Contract comparison may be carried out both internally within securities lending participant firms and offered as services to those participant firms by various vendors. Many participants send a snapshot of their book of contracts at the close of business to a common vendor who then compares all the contracts from all the participants and then reports them by displaying them within a typical comparison application. Only contracts that have breaks and orphan contracts are reported in a typical comparison application.

### SUMMARY

Applicants disclose systems and methods for managing securities lending records. In an example embodiment, the disclosed systems and methods involve comparison of contracts that have been designated as orphans in order to identify those contracts that may not truly be orphans, but rather records with an incorrectly recorded parameter.

There are two sides, in effect two contracts, or two sets of contracts that represent a securities lending agreement, with one side representing the lender and another side representing the borrower. Every parameter within the two sides must either be the same, or in net agreement, or in agreement according to regulatory guidelines, except for the client and counterparty parameters, which are flipped in each side. Every day, participants submit records of all their securities lending contracts to vendors to have them compared to ensure they are in agreement and the results are displayed within typical contract comparison applications, in the context of positions which are a grouping of contracts according to the position-forming parameters, comprising a party, a counterparty, a security. The comparison results show both sides of the contracts and highlight the field(s) that are not in agreement which are referred to as breaks.

The results also show orphan contracts, which are contracts for which the other side is missing, or appears to be missing for a variety of reasons. Two of the reasons for the existence of orphans lead to a condition where the other side of contracts are not actually missing from the comparison record, but are in the wrong position because while they exist within the record and may be in full agreement in the other parameters, they disagree in the position-forming parameters and so end up in the wrong position.

Applicants have disclosed herein a service that provides an additional comparison process directed at only the orphan contracts revealed by ordinary contract comparison. The goal of orphan contract comparison is to find any potential matches within all the orphans in the comparison record. The process involves further comparison of only the remaining orphans following ordinary contract comparison. This process of orphan contract comparison can work to find orphan matches for any type of securities lending contract comparison, such as collateral comparison or repo comparison, as long as the ordinary comparison process reveals orphans created by disagreement in the position-forming parameters.

The orphan contract comparison process occurs in several passes. The first pass views the contracts on a one-loan-to-one-borrow basis looking for perfect matches. It compares all the orphan contracts while masking out the position forming parameter security as a comparison parameter. In effect, it asks the question, “if I ignore the security parameter, does everything else in the orphan contract match?” If every other parameter is a match, then the process has identified the other side of an orphan and will store the data for later display of both contracts as a possible match.

Next, the process considers orphans contracts with a one-loan-to-one-borrow relationship that are broken in the position forming parameter security but may also have additional breaks. So the process then does the same thing while masking out security, but this time looks for matches with possible breaks in other orphan contract parameters. Again, if it finds any matches, it stores them for later display as a potential match while also showing any breaks in the non-position-forming parameters.

The next pass again views the contracts on a one-loan-to-one-borrow basis looking for perfect matches. This time it compares all the orphan contracts while masking out the position forming parameter counterparty as a comparison parameter. In effect, it asks the question, “if I ignore the counterparty parameter, does everything else in the orphan contract match?” If every other parameter is a match, then the process has identified the other side of an orphan and will store the data for later display of both contracts as a possible match.

Next, the process considers orphan contracts with a one-loan-to-one-borrow relationship that are broken in the position forming parameter counterparty but may also have additional breaks. So the process then does the same thing while masking out counterparty, but this time looks for matches with possible breaks in other orphan contract parameters. Again, if it finds any matches, it stores them for later display as a potential match while also showing any breaks in the non-position-forming parameters.

In markets outside the United States such as Europe and Canada, securities lending contracts are not always kept on a one-loan-to-one-borrow basis. A borrow may be fulfilled by several loans or vice versa. In other words, participants store their loans and borrows in different sized lots such that a loan may be represented by x contracts at the lender and the corresponding borrow by y contracts at the borrower, where x and y are two whole numbers greater than one. To accommodate this, orphan contract comparison, makes another pass while masking security again, however this time, it looks for multi-associated matches among orphan contracts where client and counterparty have multi-associated contract relationships and stores any matches for later display.

The next pass looks for multi-associated contract matches, this time with the counterparty masked as before and stores any matches for later display.

The process finally displays all the contracts in two categories. First, it displays the orphans caused by incorrect securities and their potential matches. Then it displays the orphans caused by incorrect counterparties and their potential matches.

At the end of the process, any remaining orphans are displayed separately as what may be considered “true” orphans or orphans whose other side was truly missing from the entire record and was not the result of a position-forming parameter disagreement.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative securities lending records management system.

FIG. 2 is a diagram depicting functional components of an illustrative securities lending records management system.

FIG. 3 is a flow diagram of a process for securities lending records management.

FIG. 4a is a diagram depicting views for presenting security position and contract data.

FIG. 4b is a diagram depicting views for presenting security position and contract data.

FIG. 5 is a diagram depicting securities lending positions and contracts.

FIG. 6 is a diagram depicting securities lending positions and contracts.

FIG. 7 is a block diagram of an exemplary computing environment that may be used to implement the systems and methods described herein.

### DETAILED DESCRIPTION OF ILLUSTRATIVE EMBODIMENTS

Applicants have developed systems and methods for managing securities lending records. Amongst other functions, the systems and methods are adapted to compare orphan records in order to identify potentially matching orphan contracts.

According to one aspect of the disclosed embodiments, the systems and methods identify records that appear to correspond to orphans, e.g., have no corresponding record for a counterparty or security, and locate records that, but for a relatively small inconsistency, may correspond to the contract record. In an example embodiment, the system receives securities lending transaction data for each of a plurality of participants in securities lending transactions. The records may be received from the entities that are a party to the securities loan/borrow, which are the entity doing the lending and the entity doing the borrowing. The transaction data comprises records corresponding to transactions entered into by the plurality of participants. For example, in an illustrative scenario, where a first firm entered into ten securities lending transactions, records relating to those ten transactions may be received. Similarly, where a second firm entered into twenty securities lending transactions, records relating to those twenty transactions may be received. In an example scenario, each transaction for each participant has a corresponding record with related parameters associated with a transaction. The plurality of parameters comprise values designating the party to the transaction, a counterparty to the transaction (e.g., the party on the other side of the contract), the security being loaned/borrowed, and the terms of the securities lending agreement. In an example scenario, the terms of the securities lending agreement corresponds to values that set out the terms of the contract such as, for example, the quantity of the security that is involved, the market value of the security involved, any interest rate that may be charged, and any other terms of the contract. The system stores the received data in a data store which may comprise, for example, one or more computerized database systems.

The system processes the received transaction data to identify records having values for the plurality of parameters that correspond to values for the plurality of parameters in another record. In an example scenario, the system queries the records in the data store to identify instances wherein a record of a transaction entered into by a first entity corresponds to a record of a transaction entered into by a second entity. In other words, the system queries the data records in order to identify the party and counterparty for transactions as determined by the corresponding data in the records. A record of a transaction entered into by a first entity may be said to correspond to a record of a transaction entered into by a second entity where the terms of the securities lending agreement and the security listed in the record of the first entity match the values in the record of the second entity, and where the counterparty identified in the first record corresponds to the party listed in the record of the second entity.

The system also processes the received transaction data to identify orphan records. The orphan records have values for the plurality of parameters that do not correspond to values for the plurality of parameters in a record of another entity. In an example scenario, the system queries the data store to identify instances wherein a record of a transaction entered into by a first entity, the party, has no apparent corresponding record for a second entity, the counterparty.

The system then compares the identified orphan records to identify orphan records that have values for the plurality of parameters, with the exception of one of the counterparty parameter and the security parameter, that correspond to values for the plurality of parameters in another orphan record. The system identifies instances wherein two orphan records match with the exception of either the security involved or the party/counterparty. Accordingly, in an example scenario, the system may identify that if the parameter identifying the security is excluded from consideration, a first record of a transaction entered into by a first entity corresponds to a second record of a transaction entered into by a second entity. In such an instance, the parameters defining the terms of the contract match as between the first and second record and the party of one of the records matches the counter-party of the other record. This scenario suggests that the first and second record may represent corresponding records, one for the party and the other for the counterparty, and that the parameter for the security may be incorrect in one or both of the records. According to another scenario, the system may identify that if the parameter identifying the counterparty is excluded from consideration, a first record of a transaction entered into by a first entity corresponds to a second record of a transaction entered into by a second entity. In such an instance, the parameters defining the terms of the contract match as between the first and second record and the security identified in the first record matches the security identified in the second record. This scenario suggests that the first and second record may represent corresponding records, one for the party and the other for the counterparty, and that the parameter for the party in one record and/or the parameter for the counterparty in the other record may be incorrect.

The system then transmits information regarding the matching orphan records that have been identified. In an example scenario, the system transmits information from a first orphan record and a second orphan record that have been identified as corresponding to each other along with a textual or visual prompt indicating the two records may be corresponding records for the same securities lending transaction. The transmitted information may further identify the one or more parameters that do not match as between the records. For example, in the scenario wherein a first orphan record and a second orphan record match with exception of the security identified therein, the information transmitted by the system identifies that the security does not match and suggests that the operator consider whether data for the security is incorrect in one or both of the records. Similarly, in the scenario wherein a first orphan record and a second orphan record match with the exception of the party and counterparty parameters, the information transmitted by the system identifies that party and counterparty information does not match and suggest that the operator consider whether data for the counterparty is incorrect in one or both of the records.

In an example embodiment, the system may be further adapted to receive responsive input either confirming that two orphan records are, in fact related, or indicating that two records identified as possibly corresponding are not, in fact, corresponding records. In the instance that an input is received that confirms two orphan records are related, the system may be further adapted to receive a correction to one or more parameters of the records and to update the database to reflect that the orphan records are related and to update the values of any parameters as needed.

### Example Computing Arrangement

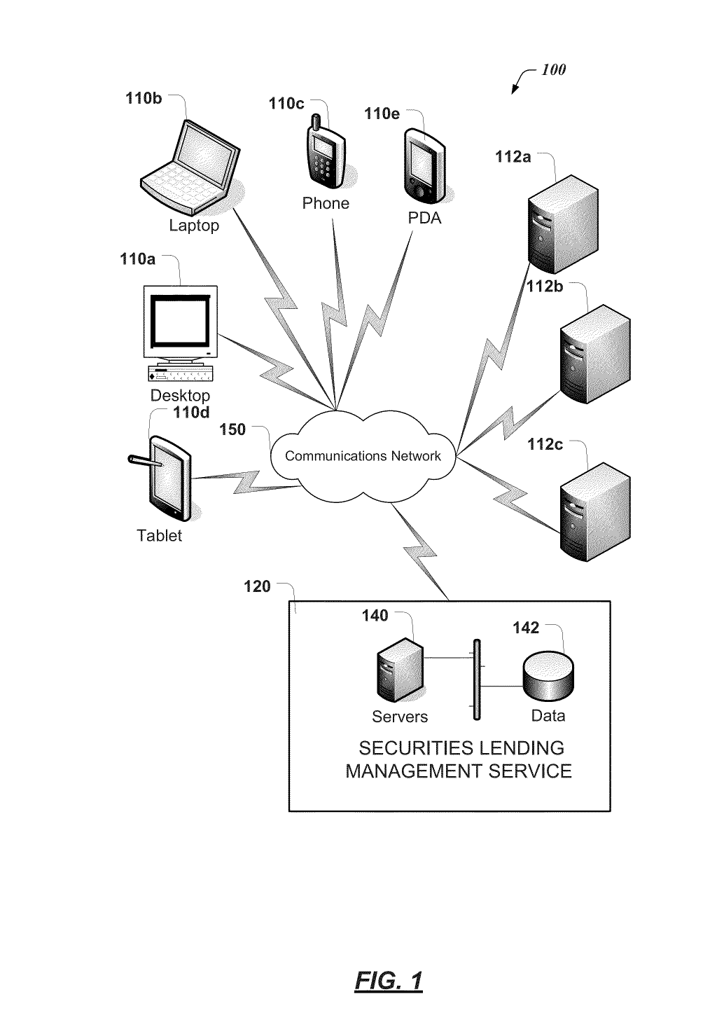

FIG. 1 illustrates an exemplary computing network 100 suitable for securities lending records management. Securities lending records management service 120 is adapted to receive data relating to securities lending transactions and to perform various management processes. In an example embodiment, securities lending records management service 120 is adapted to process securities lending transactions data in order to identify records that appear to be orphan contracts, i.e., have no corresponding counter-party transaction record that exactly match, and to compare the potential orphan contract records for the purpose of identifying records that, but for a minor inconsistency, correspond and therefore represent a potential corresponding orphan record.

In an example embodiment, service 120 comprises servers 140 which are communicatively coupled with data stores 142. Servers 140 may comprise any computing device that is adapted to perform the functionality as described herein including, for example, communicating with external data sources 112 to receive securities lending transaction data and financial market data, store the data, and process the data to identify potential orphan records and possible corresponding orphan records as described herein. Servers 140 are communicatively coupled, perhaps using a computing network, with data stores 142. Data stores 142 maintain any data that may be needed to support the functionality described herein. For example, data stores 142 may be employed to store securities lending transaction data, market data, data linking records of parties and counterparties, and any other data necessary to perform the functionality described herein. Data stores 142 may comprise any data storage technology that may be adapted to provide the functionality described herein. Any number of servers 140 and data stores 142 may be used to provide securities lending transaction records management as described herein.

Service 120 is adapted to receive securities lending transaction data from sources 112a-c via communications network 150. Sources 112a-c may be any source from which securities lending transaction data may be received including, for example, computing machines associated with brokers, clearing corporations, depositories, etc. Sources 112a-c may further include sources such as exchanges that provide current market related information. In an example embodiment, the received data may be one or more flat files that are received from customers. The files may be received at a consistent frequency such as, for example, daily. The flat files may be plain text or mixed text and binary files that may contain a single record per line or per physical record. In an example scenario, the received data might have resulted from performing an extract from a database. The extracted data may be received in any acceptable format including, for example, a .csv or an MQ feed. The received data comprises values for the parameters that define a security lending contract and include, for example, information defining the party, counterparty, the security, the interest rate or fee being charged.

Users may employ computing devices 110a-e to interface with service 120 via communications network 150. Computing devices 110a-e may be used to interface with service 120 in order to, for example, request and review information regarding securities lending transaction records. Further devices 110a-e may be used to input data such as inputs confirming that a particular orphan record corresponds to another orphan record. Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e. Computing devices 110a-e may employ any technology that is suitable to interface with service 120 including, for example, Web browser and Internet technology.

Service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof. Communications network 150 may comprise wireless, wireline, or combination thereof. In an exemplary embodiment, communications network 150 comprises the Internet and may additionally comprise any networks adapted to communicate with the Internet.

Computing arrangement 120 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

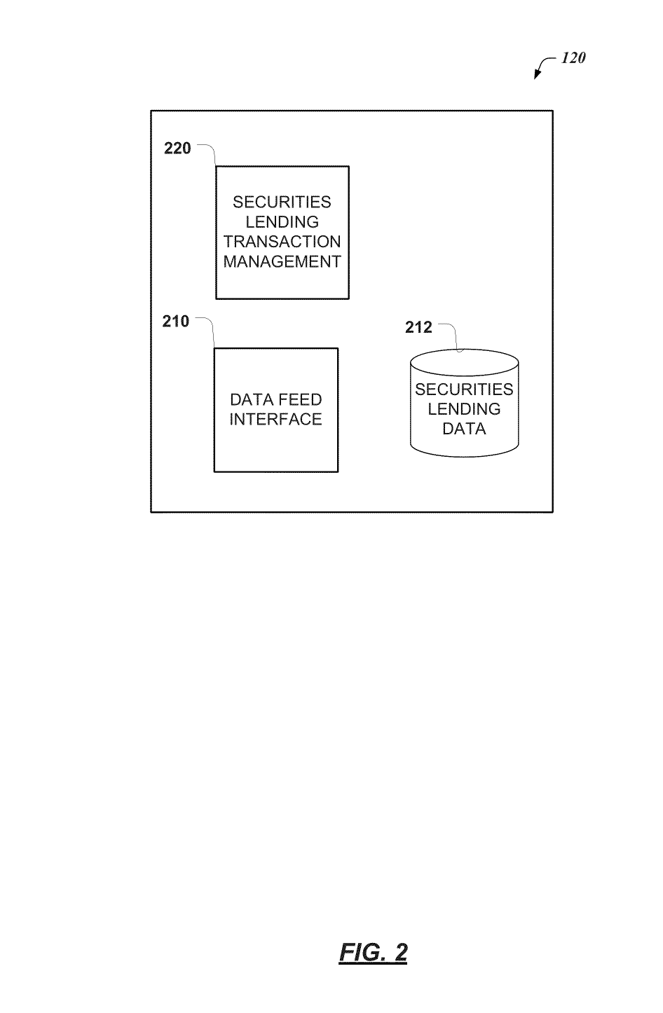

FIG. 2 depicts a block diagram illustrating exemplary logical components of an illustrative service 120 for securities lending data management. In the example embodiment of FIG. 2, server 120 comprises data feed interface functionality 210, securities lending data 212, and securities lending data management 220. Data feed interface functionality 210 allows for interfacing with external data sources 112 and storing data in data storage 142. For example, data feed interface functionality 210 provides for interfacing with brokers, clearing corporations, and exchanges 112 to receive data relating to securities lending records. Data feed interface 210 interfaces with exchanges to receive current market data including, for example, prices for stocks, bonds, and options, and interest rates.

Securities lending database 212 represents the functional database operations performed by service 120. Accordingly, access to the securities lending data is provided by securities lending database 212. Storing new data, retrieving previously stored data, and updating data is performed using securities lending database 212. Securities lending database 212 may be implemented by any suitable combination of hardware and software. For example, the functionality may be provided by any number of commercial database software systems.

Securities lending management functionality 220 performs any number of management functions on the securities lending transaction data that is made accessible. In particular, securities lending management functionality 220 queries data in the database to identify records for parties and counterparties to the same transaction and outputs an indication of such. Securities lending management functionality 220 further queries the database to identify securities lending records that do not perfectly correspond with another securities lending record. Securities lending management functionality 220 then compares the identified securities lending records that do not have an apparent corresponding record to identify instances where the parameters of the records nearly match. The instances where the records nearly match are output and feedback received either confirming or invalidating the proposed paring of records.

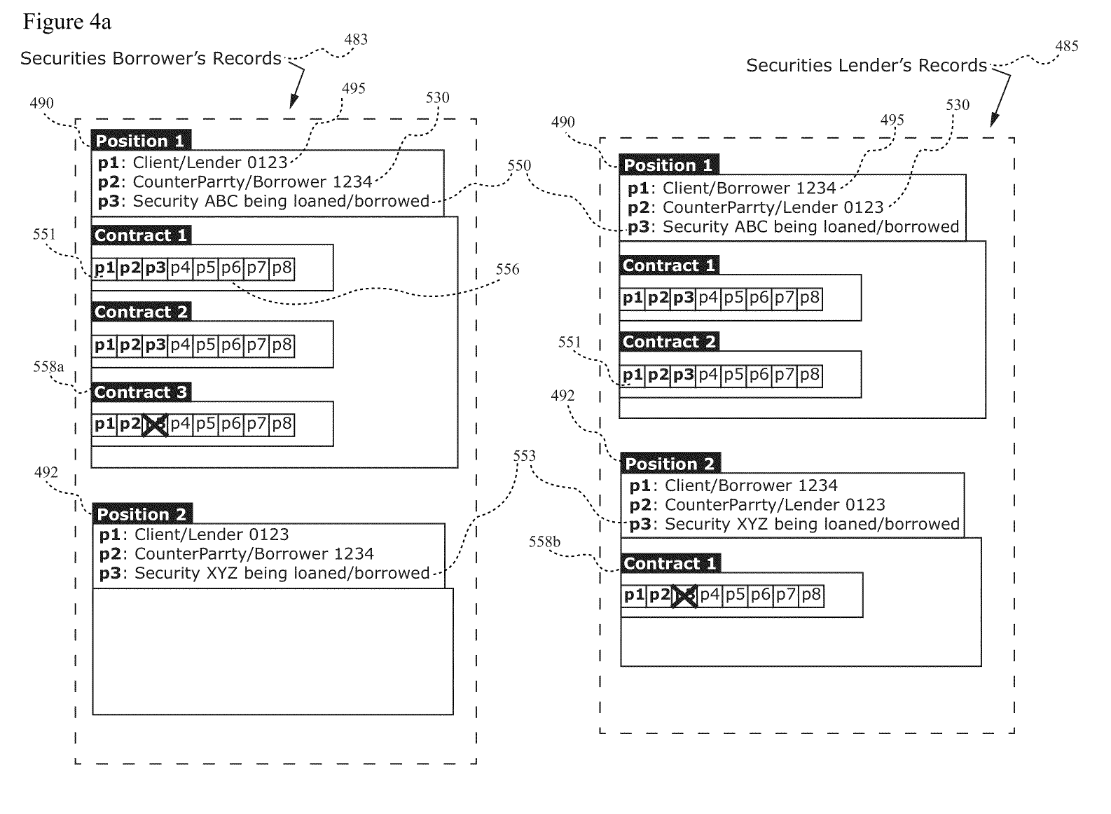

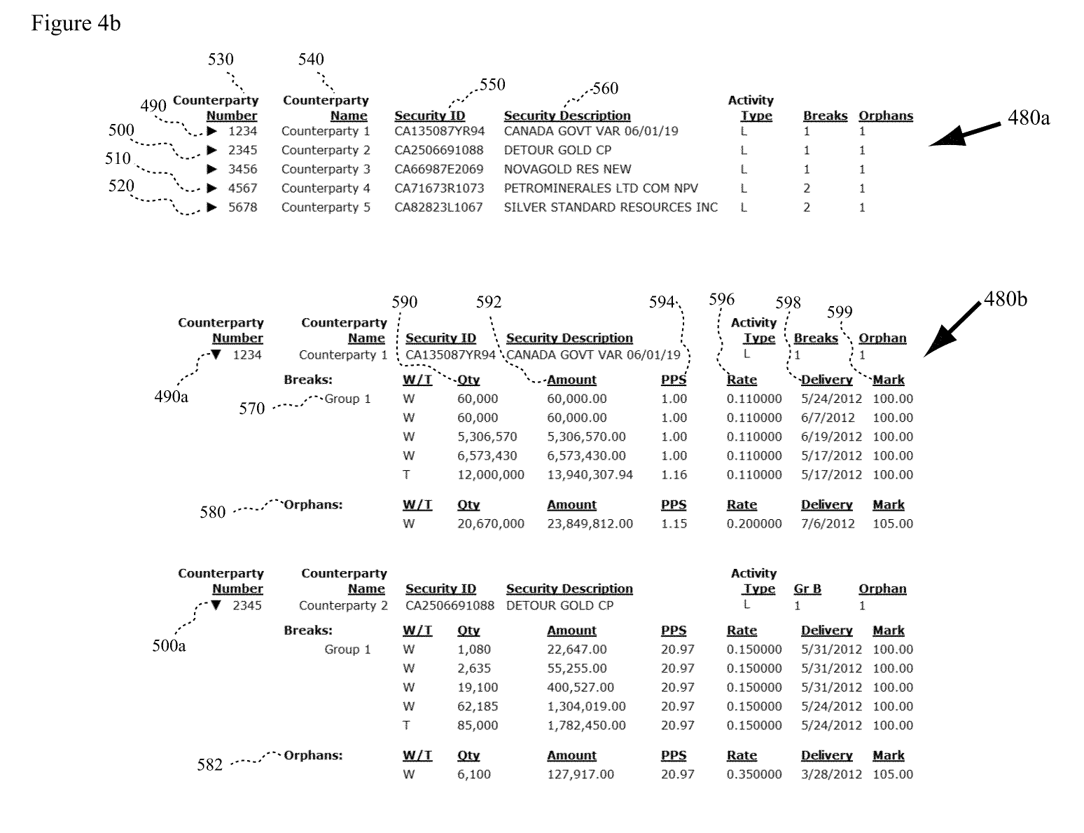

FIGS. 4a and 4b illustrate the concepts of parties and counterparties, a security position, and orphan contracts. In an example system, following a comparison process, contracts are displayed on their own or in the context of positions. Consider FIG. 4a which shows Position 1 (item 490) and Position 2 (item 492). A position may be thought of as a grouping of contracts according to some set of parameters such as p1 (item 495), p2 (item 530), p3 (item 550) in the schematic representation in FIG. 4a. In the case of contract comparison in securities lending, those position-defining parameters are usually the client (lender/borrower), the counterparty (borrower/lender), and the security being borrowed or loaned.

The set of parameters that define a position are also part of each contract as shown by item 551. Each position such as Position 1 (item 490) or Position 2 (item 492) is defined by the values of the parameters p1 as client (item 495), p2 as counterparty (item 530), and p3 as security (item 550). Any contract that shares the same values for p1, p2, and p3 with a position belongs in that position. Both sides, the borrower and the lender, keep records of the contracts as mirror images as shown in 483 and 485, that should differ only in swapping the values for client and counterparty in each contract record.

There may be several more parameters in each contract as indicated by item 556 and if any of them other than p1, p2, and p3 are different in the records kept for the borrower (item 483) and the lender (item 485), this is reported as a break between the contracts, but they are placed in the proper position because p1, p2, and p3, i.e., the position defining parameters, match. In fact, this is much of the idea behind contract comparison.

However, when there is disagreement between the position-defining parameters, the contract will end up in the wrong Position as shown by Contracts 3 (item 558a) in Position 1 whose image in the Lender's records will end up in Position 2 (item 492) as Contract 1 (item 558b). In other words, items 558a and 558b are two sides of the same contract that have ended up in different positions in the lender's and the borrower's records, in this case because they were booked using the wrong security identifier on one side or the other. In industry jargon, contracts 558a and 558b are said to be orphan contracts.

FIG. 4b provides an illustrative view of an example output from a comparison process. 480a and 480b show in representative form the perspective of only one of the parties looking at comparison results in a typical contract comparison application. It should be understood, that both sides to contract positions are provided with similar views. Item 490, as well as items 500, 510, and 520 are positions in summary form as they appear to one side of the transaction in the normal comparison display in a typical contract comparison application. In the views illustrated in in 480a and 480b, the client is always the same and in a typical comparison application is established upon login after which he/she is shown a series of positions that contain one or more contracts. However, in 480a, only five positions are shown. In practice, there are hundreds and often thousands of positions, containing dozens or even hundreds of contracts.

In this representation of a typical comparison application, the positions are displayed as rows in a table and the individual contracts that comprise them are then nested as grouped rows within each position. Reference 490 in FIG. 4a refers to a position in conceptual form. In FIG. 4b, reference 480a is the summary view of positions and position 490 appears as a row. Here 530 is the parameter analogous to p2 in FIG. 4a and they are parameters that identify the counterparty in a given position. Similarly, 550 both in FIGS. 4a and 4b refers to parameters that identify the security in a given position.

480b is an example expanded view, showing the individual contracts where 490a and 500a show the positions represented by 490 and 500 in expanded form. In the expanded view, 590, 592, 594, 596, 598, and 599 show contract parameters that are compared as part of normal comparison such as p4 through p8 (item 556 in FIG. 4a) but are not position-defining parameters. These are the contract parameters that are compared where differences between the two sides are reported as breaks in one or more groups of contracts such as the one in 570. However, by the definition of a position from above, a discrepancy in position defining parameters such as Client, Counterparty, or Security is not simply reported as a break within a position and leads to an orphan contract which in effect is a contract that is in the wrong position.

The appearance of orphan contracts is a by-product of the straight through processing of securities lending contracts and of normal comparison. In the course of normal comparison in a typical contract comparison application, orphans are set aside and shown as such in 580 and 582 which would be analogous to 558a and 558b in FIG. 4a. They are shown alongside in-position contracts with breaks. In practice, orphans point out or imply that there is a record at the borrower for a borrow, but no corresponding record at the lender for a loan or vice versa. The detection of these orphans is a by-product of contract comparison. In the systems and methods disclosed herein, contracts that are preliminarily identified as orphans are further compared with each other in order to identify and classify additional categories of orphans based on the causes of their existence.

The main causes for the existence of orphans generally fall into five main categories:
1) Incorrect securities: Orphans due to incorrect securities arise from the two sides of the transaction referring to the security being borrowed by two different identifiers instead of the same identifier.
2) Incorrect counterparties: Orphans due to incorrect counterparties are caused by the contract being correct in all other ways except being booked with the wrong counterparty.
3) No authorized relationship for comparison between the counter parties.
4) Technical Data Submission and Data integrity issues
5) All other causes

The disclosed system is adapted to match and display of orphans brought about by items 1 and 2 above, namely incorrect securities and incorrect counterparties. However, the method may be used for the matching and grouping of orphans created by similar circumstances in any kind of securities lending related comparison such as, for example, the comparing of collateral or repos.

Based on the definitions in support of FIG. 4a earlier, if an orphan is caused by the recording of an incorrect counterparty or an incorrect security, then the other side of the contract should and most often does exist and could simply appear as another orphan in another position. Since participants deal with hundreds and more often thousands of contracts daily, then two orphans such as 580 and 582—which may belong together if the counterparty or security values were to be adjusted—would be dozens and dozens of positions apart.

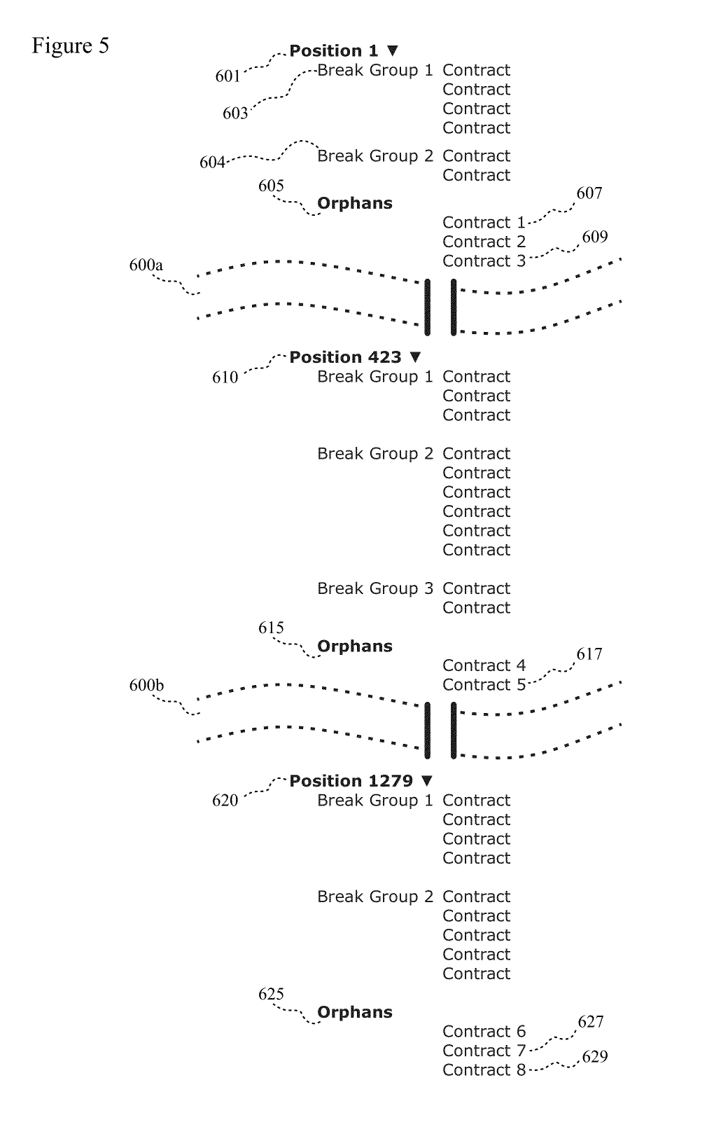

Consider FIG. 5 which is a schematic representation of this situation. 601, 610 and 620 are three positions that contain contracts with breaks and Orphan contracts. Item 601 is the first position, item 610 is the four hundred and twenty third position, and item 620 is the one thousand two hundred and seventy third position. 600a and 600b are drawing artifacts that represent the separation between these positions.

The orphan contract 1 (item 607) in Position 1 may belong with contract 8 (item 629) in position 1279. However, because it was booked with the wrong counterparty, it is 1278 positions and many hundreds of contracts away. Similarly Contract 3 (item 609) in Position 1, may belong with Contract 5 (item 617) in Position 423. However, because it was booked with the wrong security, it is 422 positions and again many hundreds of contracts away.

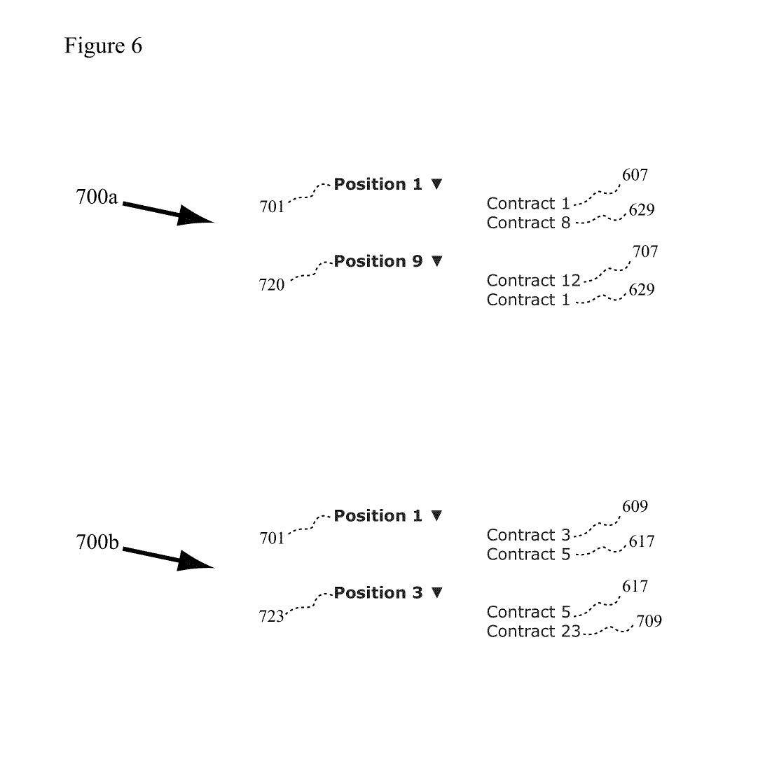

Applicants have developed systems and methods that automatically identify orphan contracts that correspond to each other. FIG. 6 depicts an example output of systems and methods consistent with those disclosed herein and corresponding to the example scenarios discussed in connection with FIGS. 4 and 5. As shown in FIG. 6, reference number 700a shows the view which results in the comparison for the orphans caused by a counterparty mismatch and 700b shows the results in the comparison for the orphans caused by a security mismatch.

Referring to display section 700a, contract 1 (item 607) in Position 1 (item 701) is now proposed as a match with Contract 8 (item 629) and Contract 1 is also proposed as a match with Contract 12 (item 707) in position 9 (item 720). Further, both Contract 1 and Contract 8 may be used again in other positions if they are viewed as potential matches with other contracts.

Similarly, and referring to display section 700b, Contract 3 (item 609) now proposed as a match with Contract 5 (item 617). Once again both Contract 3 and Contract 5 may be used again in other positions, if they are viewed as potential matches with other contracts as shown in item 723, Position 3 where Contract 5 is again proposed as a match with Contract 23, (item 709).

The positions assembled as a result of the disclosed orphan contract comparison only contain relevant matching orphan contracts that are matched (or associated with breaks) in all other comparison parameters and would not be orphans were it not for position-forming parameter disagreement, thus saving the operator the time and overhead of ensuring all other contract parameters indeed do match.

When the potentially related orphans are displayed together, the disclosed systems and methods allow the operator to associate the related orphans and in effect explicitly state that these orphans belong together as two sides of the same transaction. This association is then recorded and stored and is used the following day to inform the normal comparison process so that given the same conditions and circumstances as the previous day the associated orphans are no longer treated as orphans, but as normal contracts within a position, even if they still carry their disagreement in position-forming parameters.

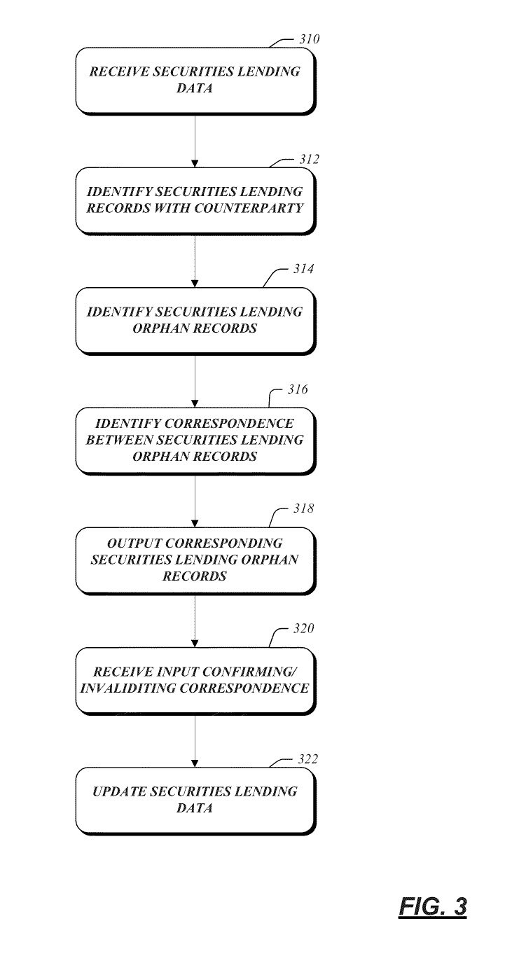

FIG. 3 depicts a flow chart of example processing performed in a securities lending records management service 120. As shown, at block 310, service 120 receives securities lending transaction data from various sources 112a-c. The data may be received as part of an automated process or in response to a request from server 140. The records may be received from the entities that are a party to the trade, a broker that executed the trade, a firm that operates as a clearinghouse, or any other entity that has the relevant securities lending data. Service 120 may also simultaneously receive market data including, for example, the current market price of stocks, bonds, and options, as well as current interest rates. The transaction data comprises records corresponding to securities lending transactions. For example, in an illustrative scenario, where a first firm entered into ten securities lending transactions, records relating to those ten transactions may be received. Similarly, where a second firm entered into twenty securities lending transactions, records relating to those twenty transactions may be received. The transaction data comprises information that specifies the parameters for each transaction. The records specify positions and contracts that the firm entered into with other firms. In an example scenario, each transaction for each participant has a corresponding record with related parameters associated with a transaction for the particular participant. As described above in detail in connection with FIG. 4a, the plurality of parameters comprise values designating the party to the transaction, a counterparty to the transaction (e.g., the party on the other side of the contract), a security that was the subject of the securities lending, and the other terms of a securities lending agreement. In an example scenario, the terms of the securities lending agreement correspond to values that set out the terms of the contract such as, for example, the quantity of the security that is involved, the market value of the security involved, any interest rate that may be charged, any requirements for collateral, and any other terms of the contract. Service 120 stores the received securities lending data in data store 142. Accordingly, data store 142 comprises records that define securities lending transactions that have been entered into by a plurality of different market participants. Securities lending data management service 120 is adapted to query data store 142 so as to compare the records from the various market participants in order to identify instances where the records correspond, i.e., records for the party and counterparty exist and are consistent, as well as those instances where the records do not exactly correspond, i.e., there is no record unambiguously defining a counterparty.

At block 312, securities lending data management service 120 processes the received transaction data in data store 142 to identify records having values for the plurality of parameters that correspond to values for the plurality of parameters in another record. The processing may be initiated in any number of circumstances including, for example, as part of an automated management process or in response to a request from one of devices 110a-e. In an example scenario, service 120 queries the records in data store 142 to identify instances wherein a record of a transaction entered into by a first entity corresponds to a record of a transaction entered into by a second entity. In an example scenario, service 120 may compare data to identify positions and corresponding contracts for a first entity that match positions and corresponding contracts for one or more other entities. In other words, service 120 queries the data records in order to identify the corresponding party and counterparty for transactions as determined by the corresponding data in the records. A record of a transaction entered into by a first entity corresponds to a record of a transaction entered into by a second entity wherein the terms of the finance agreement and the security listed in the record of the first entity match the values in the record of the second entity, and wherein the counterparty identified in the first record corresponds to the party listed in the record of the second entity and vice versa. Service 120 identifies instances wherein the securities lending records of two entities exactly correspond and thereby indicate the records represent two sides to the same transaction. As noted previously, a contract may be used in multiple different positions. Accordingly, in an example scenario, service 120 when processing the financial records may identify one-to-many matches with no breaks, then for many-to-many matches, many-to-one, or one-to-many associations with no breaks. In such a scenario, service 120 may then search for matches between contracts that contain breaks. At the end of the process, any remaining orphans are displayed separately as what may be considered “true” orphans. Service 120 may identify a plurality of instances wherein the records exactly correspond, and thereafter may communicate a listing of such instances over network 150 to a device 110.

At block 314, service 120 processes the received transaction data to identify orphan records. Orphan records have values for the plurality of parameters that do not correspond to values for the plurality of parameters in another record. In an example scenario, service 120 queries the data store 142 to identify instances wherein a record of a transaction entered into by a first entity has no apparent corresponding record for a counterparty. For example, service 120 may identify records for contracts that do not have an exact matching record from another party. In some instances, these may represent “breaks” as describe above. In other instances, where no corresponding counterparty or security can be identified, these may represent orphan contracts. In particular, service 120 queries data store 142 in order to identify instances wherein a record of a securities lending transaction does not have a corresponding record with corresponding values for the record parameters. For instance, service 120 identifies records that have a combination of a value for the security parameter, counterparty, and terms of a securities lending agreement that do not correspond to any other record in data store 142. In an example scenario, service 120 identifies orphan records or records corresponding to orphan contracts. It should be appreciated that the operations described connection with block 314 may be performed at the same time as or in connection with the operations performed at block 312.

At block 316, service 120 queries data store 142 in order to compare the identified orphan records so as to identify orphan records that have values for the plurality of parameters with the exception of one of the party/counterparty parameter and the security parameter that correspond to values for the plurality of parameters in another orphan record. In other words, service 120 identifies instances wherein two orphan records match with the exception of either the security involved or the party/counterparty.

Accordingly, in an example scenario, service 120 may identify that if the parameter identifying the security parameter is excluded from consideration, a first record of a transaction entered into by a first entity corresponds to a second record of a transaction entered into by a second entity. In other words, service 120 compares records for orphan contracts to identify instances where the orphan contracts may actually correspond to each other. In an example embodiment, service 120 may perform a first pass where it essentially masks out the security parameter while comparing all the other orphan contract parameters and looks for perfect matches on a one-loan-to-one-borrow basis. Effectively, from the perspective of the client, the process takes all the orphans from a given client-counterparty relationship and masks out security as a comparison parameter and looks at all the other orphans with all other counterparties and looks for any perfect matches in all the other parameters. In such an instance, the parameters defining the terms of the contract match as between the first and second record and the party of one of the records matches the counter-party of the other record. This scenario suggests that the first and second record may represent corresponding records, one for the party and the other for the counterparty, and that the parameter for the security may be incorrect in one or both of the records.

In an example embodiment, service 120 may first search for perfect matches where all parameters between contracts match with the exception of the security. In such an embodiment, service 120 may thereafter perform a similar search but not require perfect correspondence between all parameters other than security, and thus allow for breaks in contracts. Accordingly, in such an embodiment, after identifying all perfect matches when the security is masked out, the process takes all the orphans from a given client-counterparty relationship and masks out security as a comparison parameter and looks at all the other orphans with all other counterparties and looks for matches, although not perfect, in the other parameters. Such a scenario identifies potential matches between orphan contracts that may also involve breaks as between contracts with respect to any no-position-forming parameters.

Service 120 may store the results of the search and processing.

According to another scenario, service 120 may perform another pass of the data wherein it identifies that if the parameter identifying the counterparty is excluded from consideration, a first record of a transaction entered into by a first entity corresponds to a second record of a transaction entered into by a second entity. Service 120 essentially masks out the counterparty while comparing all the other orphan contract parameters and looks for perfect matches on a one-loan-to-one-borrow basis. Effectively, service 120 takes all the orphans from a given client-security relationship and masks out counterparty as a comparison parameter and looks at all the other orphans within that security and looks for any perfect matches in all the other parameters. In such an instance, the parameters defining the terms of the contract match as between the first and second record and the security identified in the first record matches the security identified in the second record. This scenario suggests that the first and second record may represent corresponding records, one for the party and the other for the counterparty, and that the parameter for the party in one record and/or the parameter for the counterparty in the other record may be incorrect.

In an example embodiment, service 120 may first search for perfect matches where all parameters between contracts match with the exception of the counterparty. In such an embodiment, service 120 may then perform a similar search but not require perfect correspondence between all parameters other than counterparty, and thus allow for breaks in contracts. The system may perform the same searching for matches while masking out the counterparty, but allow for matches with possible breaks in other orphan contract parameters.

Service 120 may store the results of the search.

In an example embodiment, service 120 may then perform additional processing in order to identify multi-associated matches, which may be, for example, one-to-many and many-to-many matches or relationships between contracts. In the above-described searches, service 120 may search for one-to-one relationships between contracts, which is typically associated with markets in the United States. However, for markets outside the United States such as Europe and Canada, securities lending contracts are not always kept on a one-loan-to-one borrow basis. A borrow may be fulfilled by several loans or vice versa. In other words, participants store their loans and borrows in different sized lots such that a loan may be represented by “x” contracts at the lender and the corresponding borrow by “y” contracts at the borrower, where “x” and “y” are two whole numbers greater than one. In order to address such circumstances, service 120 may again mask the security parameter, but this time, it searches the records for multi-associated matches among the contracts where the client and counterparty store their loans and borrows in different shapes and sizes such that a loan may be represented by x contracts at the client and the corresponding borrow by y contracts at the counterparty, where x and y are two whole numbers greater than one. Service 120 may perform a similar processing but with the counterparty masked, while it searches for multi-associated matches within a client and the security.

At block 318, service 120 transmits information regarding the matching orphan records that have been identified. The information may be transmitted over communications network 150 to one of devices 110. In an example scenario, service 120 transmits information from a first orphan record and a second orphan record that have been identified as possibly corresponding to each other along with a textual or visual prompt indicating the two records may be corresponding records for the same securities lending transaction. In an example scenario, the information may be formatted in a manner similar to the paradigm employed in connection with FIG. 4 but with the additional concept of matching orphans as discussed in connection with FIG. 6. The transmitted information may further identify the one or more parameters that do not match. For example, in the scenario wherein a first orphan record and a second orphan record match with exception of the security identified therein, the information transmitted by the system identifies that the security does not match and suggests that the operator consider whether data for the security is incorrect in one or both of the records. Similarly, in the scenario wherein a first orphan record and a second orphan record match with the exception of the party and counterparty parameters, the information transmitted by the system identifies that party and counterparty information does not match and suggest that the operator consider whether data for the party/counterparty is incorrect in one or both of the records. The information may be transmitted in any format that is suitable for display on the end user device. For example, the information may be formatted to be displayed using a Web interface.

At block 320, service 120 may be further adapted to receive responsive input. The responsive inputs may, for example, confirm that two orphan records are, in fact, related and correspond to the same transaction. Alternatively, the inputs may indicate that two orphan records that service 120 identified as possibly corresponding, do not, in fact, relate to the same securities lending transaction. In the instance that the input is a confirmation that two orphan records relate to the same transaction, service 120 may receive further inputs identifying changes that should be made to one or both of the particular orphan records. For example, an input may be received providing replacement information for the security parameter or the counterparty parameter. The inputs may be received, for example, as communications from devices 110.

At block 322, in response to any input that may be received, service 120 updates the data in data store 142. For example, in the instance that an input is received that confirms two orphan records are related, service 120 may update data store 142 to record that there is a connection between two records. Further, if the input contains a replacement value for a parameter, service 120 may update data store 142 to record the update. For example, if an input is received providing a replacement value for the security parameter or counterparty parameter, service 120 updates data store with the replacement value.

### Example Computing Environment

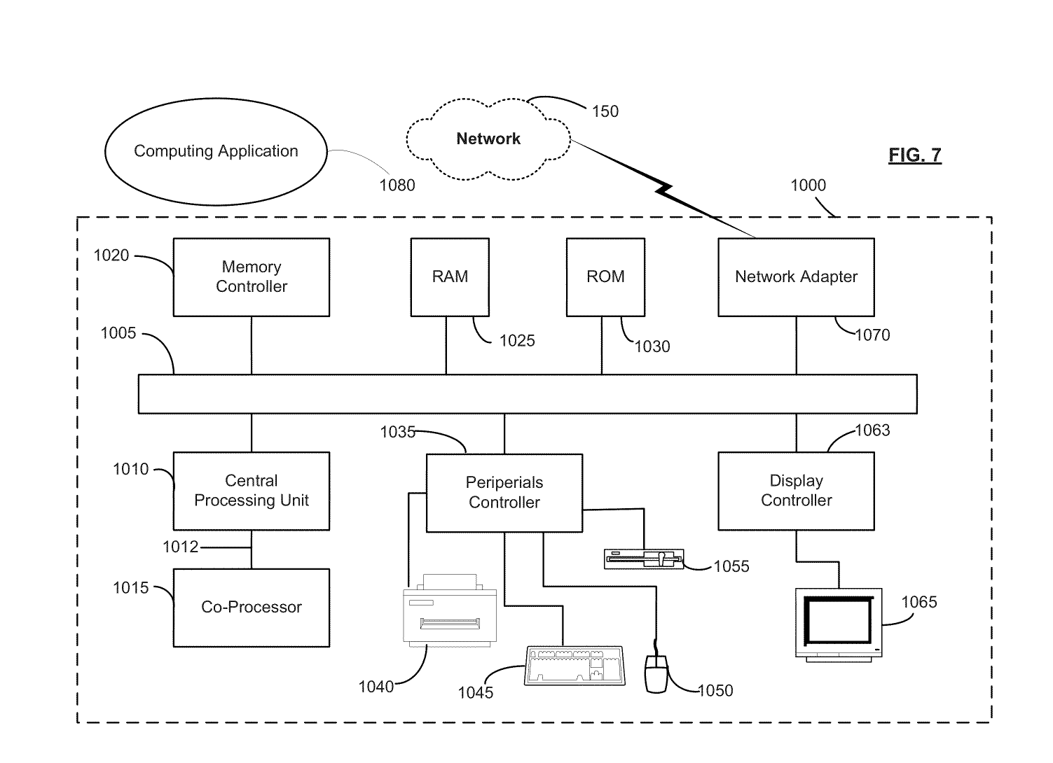

FIG. 7 depicts a block diagram of an exemplary computing system 1000 that may be used to implement the systems and methods described herein. For example, the computing system 1000 may be used to implement the securities lending management service 120 as well as any of devices 140, 110a-e and 112a-c. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Accordingly, applicants have disclosed exemplary embodiments of systems and methods for securities lending data management. The disclosed systems and method provide for compiling securities lending records for a plurality of securities lending transaction participants. The securities lending records may correspond to securities lending positions and contracts corresponding to those positions. The systems and methods provide for querying the securities lending records and identifying those that have parameters that exactly correspond. The systems and methods further provide for querying the securities lending records to identify orphan records for which there is no record that perfectly matches with respect to all parameters. The identified orphan records may be further analyzed to identify instances wherein another record corresponds with respect to all parameters with the exception of one or two. The potentially corresponding orphan records are presented to an end user. The end user may then input a confirmation that the records are, in fact, related, along with an update to one or more parameters of one or both of the records. A user of the disclosed systems and methods is thereby enabled to quickly identify securities lending records that based upon existing data appear to be orphans, but, in fact, are not orphans and simply have incorrect parameter values.

It will be appreciated that while illustrative embodiments have been disclosed, the scope of potential embodiments is not limited to those explicitly set out. For example, while the system has been described with reference to particular scenarios wherein the security parameter or party/counterparty do not match, the envisioned embodiments extend beyond a particular parameter not matching as between securities lending records.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. Large corporations may internally monitor multiple users within an exemplary embodiment platform to direct media placement. The potential embodiments may be developed and programmed in any web based technology platform. Alternatively, a potential embodiment may be implemented as a standalone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for processing securities lending data, comprising:
receiving at a computing system transaction data for each of a plurality of participants in securities lending transactions, the transaction data comprising records corresponding to transactions entered into by the plurality of participants, each record comprising information for a plurality of parameters associated with a transaction, the plurality of parameters comprising a party, a counterparty, a security, and terms of a securities lending agreement;
processing the received transaction data to identify records having values for the plurality of parameters that correspond to values for the plurality of parameters in another record;
processing the received transaction data to identify orphan records, the orphan records having values for the plurality of parameters that do not correspond to values for the plurality of parameters in another record;
comparing the identified orphan records to identify orphan records that have values for the plurality of parameters, with the exception of one of the party parameter and the security parameter, that correspond to values for the plurality of parameters in another orphan record;
for each orphan record having values for the plurality of parameters, with the exception of one of the counterparty parameter and the security parameter, that correspond to values for the plurality of parameters in another orphan record, transmitting information specifying a correspondence with the another orphan record.

2. The computer-implemented method of claim 1, further comprising receiving an input confirming that one orphan record corresponds to another orphan record.

3. The computer-implemented method of claim 1, wherein the terms of a securities lending agreement comprise: quantity of a security; price of the security; and interest rate.

4. The computer-implemented method of claim 1, wherein processing the received transaction data to identify records having values for the plurality of parameters that correspond to values for the plurality of parameters in another record comprises processing the received transaction data to identify records wherein a counterparty in a first record matches a party in a second record and a security in the first record matches a security in the second record.

5. The computer-implemented method of claim 1, wherein comparing the identified orphan records to identify orphan records that have values for the plurality of parameters, with the exception of one of the counterparty parameter and the security parameter, that correspond to values for the plurality of parameters in another orphan record, comprises identifying orphan records that have values for the plurality of parameters with the exception of the security parameter that correspond to values for the plurality of parameters in another orphan record.

6. The computer-implemented method of claim 5, wherein identifying orphan records that have values for the plurality of parameters with the exception of the security parameter that correspond to the values for the plurality of parameters in another orphan record comprises identifying one-to-one matches between orphan records.

7. The computer-implemented method of claim 5, wherein identifying orphan records that have values for the plurality of parameters with the exception of the security parameter that correspond to the values for the plurality of parameters in another orphan record comprises identifying one-to-many matches between orphan records.

8. The computer-implemented method of claim 5, wherein identifying orphan records that have values for the plurality of parameters with the exception of the security parameter that correspond to the values for the plurality of parameters in another orphan record comprises identifying many-to-many matches between orphan records.

9. The computer-implemented method of claim 1, wherein comparing the identified orphan records to identify orphan records that have values for the plurality of parameters, with the exception of one of the counter party parameter and the security parameter, that correspond to values for the plurality of parameters in another orphan record, comprises identifying orphan records that have values for the plurality of parameters with the exception of the counterparty parameter that correspond to values for the plurality of parameters in another orphan record.

10. The computer-implemented method of claim 9, wherein identifying orphan records that have values for the plurality of parameters with the exception of the counterparty parameter that correspond to the values for the plurality of parameters in another orphan record comprises identifying one-to-one matches between orphan records.

11. The computer-implemented method of claim 9, wherein identifying orphan records that have values for the plurality of parameters with the exception of the counterparty parameter that correspond to the values for the plurality of parameters in another orphan record comprises identifying one-to-many matches between orphan records.

12. The computer-implemented method of claim 10, wherein identifying orphan records that have values for the plurality of parameters with the exception of the counterparty parameter that correspond to the values for the plurality of parameters in another orphan record comprises identifying many-to-many matches between orphan records.

13. The computer-implemented method of claim 9, wherein identifying orphan records that have values for the plurality of parameters with the exception of the counterparty parameter that correspond to values for the plurality of parameters in another orphan record comprises identifying orphan records that have values for the plurality of parameters that correspond to values for the plurality of parameters in another orphan record with the exception that the party parameter does not match a counter-party parameter in another orphan record.

14. The computer-implemented method of claim 1, wherein for each orphan record having values for the plurality of parameters, with the exception of one of the counterparty parameter and the security parameter, that correspond to values for the plurality of parameters in another orphan record, transmitting information specifying a correspondence with the another orphan record comprises transmitting information identifying a first orphan record and transmitting information identifying a second orphan record as corresponding to the first orphan record.

15. The computer-implemented method of claim 2, further comprising receiving an input comprising a replacement value for an existing value for a parameter of a record.

16. A computing system adapted for securities lending data management processing, comprising:
a computing processor; and
computing memory communicatively coupled with the computing processor, the computing memory having executable instructions stored therein that when executed by the computing system cause the computing system to perform an operations comprising:
receiving at a computing system transaction data for each of a plurality of participants in securities lending transactions, the transaction data comprising records corresponding to transactions entered into by the plurality of participants, each record comprising information for a plurality of parameters associated with a transaction, the plurality of parameters comprising a party, a counterparty, a security, and terms of a securities lending agreement;
processing the received transaction data to identify orphan records, the orphan records having values for the plurality of parameters that do not correspond to values for the plurality of parameters in another record;
comparing the identified orphan records to identify orphan records that have values for the plurality of parameters, with the exception of one of the party parameter and the security parameter, that correspond to values for the plurality of parameters in another orphan record;
for each orphan record having values for the plurality of parameters, with the exception of one of the counterparty parameter and the security parameter, that correspond to values for the plurality of parameters in another orphan record, transmitting information specifying a correspondence with the another orphan record.

17. The system of claim 16, wherein the computing memory has further executable instructions stored therein that when executed by the computing system cause the computing system to perform further operations comprising receiving an input confirming that one orphan record corresponds to another orphan record.

18. The system of claim 16, wherein the terms of a securities lending agreement comprise: quantity of a security; price of the security; and interest rate.

19. The system of claim 16, wherein processing the received transaction data to identify records having values for the plurality of parameters that correspond to values for the plurality of parameters in another record comprises processing the received transaction data to identify records wherein a counterparty in a first record matches a party in a second record and a security in the first record matches a security in the second record.

20. The system of claim 16, wherein comparing the identified orphan records to identify orphan records that have values for the plurality of parameters, with the exception of one of the counterparty parameter and the security parameter, that correspond to values for the plurality of parameters in another orphan record, comprises identifying orphan records that have values for the plurality of parameters with the exception of the security parameter that correspond to values for the plurality of parameters in another orphan record.

21. The system of claim 16, wherein comparing the identified orphan records to identify orphan records that have values for the plurality of parameters, with the exception of one of the counter party parameter and the security parameter, that correspond to values for the plurality of parameters in another orphan record, comprises identifying orphan records that have values for the plurality of parameters with the exception of the counterparty parameter that correspond to values for the plurality of parameters in another orphan record.

22. The system of claim 21, wherein identifying orphan records that have values for the plurality of parameters with the exception of the counterparty parameter that correspond to values for the plurality of parameters in another orphan record comprises identifying orphan records that have values for the plurality of parameters that correspond to values for the plurality of parameters in another orphan record with the exception that the party parameter does not match a counter-party parameter in another orphan record.

23. The system of claim 16, wherein for each orphan record having values for the plurality of parameters, with the exception of one of the counterparty parameter and the security parameter, that correspond to values for the plurality of parameters in another orphan record, transmitting information specifying a correspondence with the another orphan record comprises transmitting information identifying a first orphan record and transmitting information identifying a second orphan record as corresponding to the first orphan record.

24. The system of claim 17, wherein the computing memory has further executable instructions stored therein that when executed by the computing system cause the computing system to perform further operations comprising a replacement value for an existing value for a parameter of a record.

25. A tangible computer readable media having executable instructions stored therein that when executed by a computing system cause the computing system to perform an operations comprising:
storing in a database transaction data for each of a plurality of participants in securities lending transactions, the transaction data comprising records corresponding to transactions entered into by the plurality of participants, each record comprising information for a plurality of parameters associated with a transaction, the plurality of parameters comprising a party, a counterparty, a security, and terms of a securities lending agreement;
querying the received transaction data to identify orphan records, the orphan records having values for the plurality of parameters that do not correspond to values for the plurality of parameters in another record;
querying the received transaction data to identify orphan records that have values for the plurality of parameters, with the exception of one of the counterparty parameter and the security parameter, that correspond to values for the plurality of parameters in another orphan record.

26. The tangible computer readable media of claim 25 further comprising executable instructions stored therein that when executed by the computing system cause the computing system to perform further operations comprising:
for each orphan record having values for the plurality of parameters, with the exception of one of the counterparty parameter and the security parameter, that correspond to values for the plurality of parameters in another orphan record, transmitting information specifying a correspondence with the another orphan record.
